(19) United States
(12) Patent Application Publication
(10) Pub. No.: US 2016/0232572 A1
(43) Pub. Date: Aug. 11, 2016

(54) Public Transport Advertising Using Passenger Demographic Information

(71) Applicant: DIGITAL UNDERGROUND MEDIA INC., North Vancouver (CA)

(72) Inventors: Neil Paul East, Winnipeg (CA); Oswald Kenneth Bicknell, North Vancouver (CA)

(21) Appl. No.: 15/023,260

(22) PCT Filed: Sep. 18, 2014
(86) PCT No.: PCT/CA2014/050891

§ 371 Date: Mar. 18, 2016

Related U.S. Application Data
(60) Provisional application No. 61/879,367, filed on Sep. 18, 2013.

(51) Int. Cl. G06Q 30/02; H04W 4/20; H04W 4/04

(52) U.S. Cl. CPC G06Q 30/0261; G06Q 30/0269; G06Q 30/0267; H04W 4/046; H04W 4/206

(57) ABSTRACT

Demographic information obtained from mobile devices of passengers of a public transport system is stored and subsequently used in selection of advertising content to be displayed to the users of mobile devices on an independent display. The advertisement may take the form of a video displayed on the display in the public transport system together with enriched data, for example audio content or auxiliary advertising content which is associated with the advertisement, in which the enriched data is sent to the plurality of users over a wireless network to be playable on the mobile devices. Confirmation of the advertisement being displayed is then stored on a computer database together with the demographic information associated with the mobile devices of the plurality of users to which the advertising was displayed.

### FIELD OF THE INVENTION

The present invention relates to a method of storing demographic information derived from mobile devices of passengers of a public transport system and a method displaying advertising to users of mobile devices on an independent display based upon demographic information derived from the mobile devices.

### BACKGROUND

It is generally known in advertising that targeting advertisements to the optimal demographics of the recipients is a better use of resources than non-targeted advertising. Accordingly, it is desirable to know the demographics of the audience potentially viewing any advertisements.

Various attempts to display advertising on smart phones is known which attempts to target an advertisement according to certain demographic information about the user of the smart phone. Any known techniques however are not readily adaptable to public displays for advertising, for example advertising displays associated with public transport.

### SUMMARY OF THE INVENTION

According to a first aspect of the invention there is provided a method of collecting demographic information relating to a plurality of users of at least one route of a public transportation system, the method comprising:

providing a wireless communication device in proximity to the public transportation system;

communicating wirelessly with any mobile devices of said plurality of users using the wireless communication device so as to determine a mobile device identification of each mobile device of said plurality of users;

storing the mobile device identifications in a computer database; and

storing additional demographic information in association with each mobile device identification on the computer database.

By storing the phone identifications of numerous users, a history of each user identified by their phone identification can be accumulated. Transportation patterns relating to each user can then be determined so that the patterns allow certain demographic assumptions about the users to be made. This information can also be combined with other demographic information acquired passively, for example through wireless connections of the phone, or actively, for example through an application executable on mobile devices of the users or through partnerships with wireless service providers and the like. The collected demographic information is useable both for advertising in the public transport environment as well as other general advertising uses. Even if users have not opted to share additional demographic information through an executable application for example, the transport patterns associated with each user alone is potentially valuable demographic information as certain assumptions can be made about the user. For example, an assumption of the career of a user may be made based on commute times and destinations determined from the transport patterns acquired by the present invention.

Examples of demographic information may include a route identification of a route of the public transportation system, a transportation boarding location of the user, a transportation disembarking location of the user, a time and date of transport of the user, user information from a mobile service provider, user information derived from an application executed on the mobile device, or any combination thereof.

The public transportation system may be a subway, a train, a streetcar, a bus, a plane, a taxi or the like.

The wireless communication device may be located at a boarding location of the public transportation system, a disembarking location of the public transportation system, along a route of the public transportation system, on a vehicle of the public transportation system, or any combination thereof of the public transportation system.

Displaying an advertisement to the plurality of users of the public transportation system may be accomplished according to the demographic information associated with the mobile devices of the plurality of users by: i) selecting one advertisement among a plurality of advertisements having a demographic rating which is most closely related to the demographic information associated with the mobile devices of the plurality of users, and ii) displaying the selected advertisement.

Before or during display of an advertisement to the plurality of users of the public transportation system, the mobile devices of the plurality of users may be prompted to acquire enriched data associated with the advertisement from a mobile network through an application executable on the mobile device. User information derived from said application executable on the mobile device may then also be stored on the computer database in association with the respective mobile device identification for future use. The enriched data may be in the form of audio content for example which is playable on the mobile device of each user in coordination with the visual advertisement. The audio content may be streamed over the mobile network.

The method may further include storing on the computer database a confirmation of the advertisement being displayed together with the demographic information associated with the mobile devices of the plurality of users. When displaying the advertisement along a selected route of the public transportation system, the method preferably includes i) determining which of the plurality of users used said selected route and ii) storing demographic information associated with the mobile devices of only the users which used the selected route on the computer database in association with the confirmation of the advertisement being displayed along the selected route. Which users used said selected route can be determined by communicating wirelessly with the mobile devices of said plurality of users at a boarding location and at a disembarking location for each user.

According to a second aspect of the present invention there is provided a method of displaying advertising to a plurality of users of mobile devices, the method comprising:

providing a display independent of the mobile devices;

providing a wireless communication device in proximity to the display;

communicating wirelessly with the mobile devices of said plurality of users using the wireless communication device so as to determine a mobile device identification and demographic information associated with each mobile device of said plurality of users;

selecting one advertisement among a plurality of advertisements having a demographic rating which is most closely related to the demographic information associated with the mobile devices of the plurality of users; and

displaying the selected advertisement on the display.

The method in this instance may further comprise: i) prompting the mobile devices of the plurality of users to execute an application on the mobile device; ii) providing enriched data which is associated with the advertisement from a mobile network to the user through said application on the mobile device; and iii) obtaining additional demographic information from the user through said application on the mobile device.

According to a third aspect of the present invention there is provided method of displaying advertising to a plurality of users of mobile devices, the method comprising:

providing a display independent of the mobile devices;

displaying a video advertisement to the plurality of users on the display; and

providing enriched data in the form of audio content which is associated with the advertisement to the plurality of users over a mobile network such that the audio content is playable on the mobile device in synchronicity with the video advertisement.

The method may include providing an application executable on the mobile device, and using said application to play the audio content by streaming the audio content over the wireless network. Alternatively the executable application may be used to play the audio content in the form of preloaded data on the mobile device which has been acquired by said application before displaying the video advertisement to the plurality of users.

Initiating playing of the audio content in synchronicity with the video advertisement may be accomplished in one embodiment by capturing a visual trigger on the independent display with a camera of the mobile device.

In an alternative embodiment, when i) the independent display is provided along a public transport route, ii) the mobile device is carried by a user on a public transport vehicle, and iii) the video advertisement is initiated by proximity of the public transport vehicle to the independent display, the method of initiating playing of the audio content in synchronicity with the video advertisement may be accomplished by calculating a proximity of the mobile device to the independent display using a departure time of the public transport vehicle from a boarding location, speed of the public transport vehicle along the route, and distance of the independent display along the route from the boarding location.

According to another aspect of the present invention there is provided a method of displaying advertising to a plurality of users of mobile devices, the method comprising:

providing a display independent of the mobile devices;

displaying a video advertisement to the plurality of users on the display;

providing auxiliary advertising content associated with said video advertisement to the plurality of users over a wireless network such that the auxiliary advertising content is playable on the mobile device.

The auxiliary advertising content may comprise video content which is a continuation of said video advertisement displayed on the independent display.

According to another aspect of the present invention there is provided a method of displaying advertising to a plurality of users of mobile devices, the method comprising:

providing a display independent of the mobile devices;

providing a wireless communication device in proximity to the display;

communicating wirelessly with the mobile devices of said plurality of users using the wireless communication device so as to determine a mobile device identification and demographic information associated with each mobile device of said plurality of users;

displaying an advertisement to the plurality of users of the public transportation system according to the demographic information associated with the mobile devices of the plurality of users;

storing a confirmation of the advertisement being displayed on a computer database; and

storing the demographic information associated with the mobile devices of the plurality of users on the computer database in association with the confirmation.

Various embodiments of the invention will now be described in conjunction with the accompanying drawings in which:

### BRIEF DESCRIPTION OF THE DRAWINGS

FIG. 1 is a schematic representation of a public transport system in the form of a subway train travelling between a boarding platform and a disembarking platform with advertising displays being provided along the route.

FIG. 2 is a schematic representation of the advertising system according to the present invention for executing the method described herein.

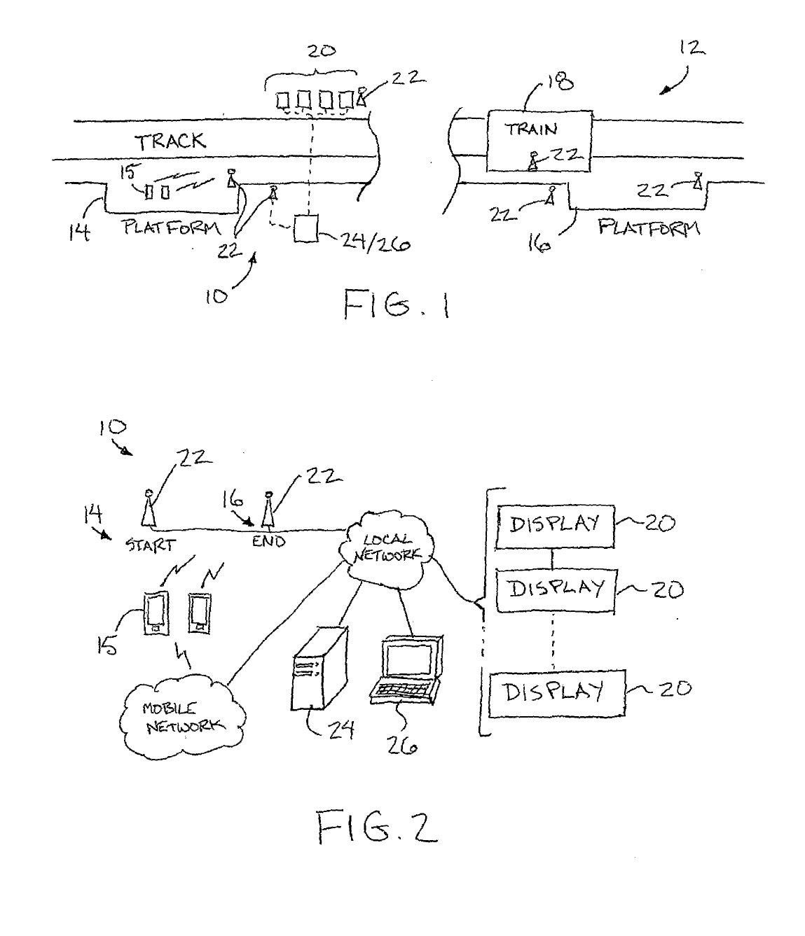

In the drawings like characters of reference indicate corresponding parts in the different figures.

### DETAILED DESCRIPTION

Referring to the accompanying figures, there is illustrated an advertising system generally indicated by reference numeral 10. The system 10 is particularly suited for use with a public transport system 12 and may operate in cooperation with a demographic collection system forming part of the overall advertising system as described in further detail below. The demographic collection system communicates with the wireless mobile devices 15 carried by users of the public transport system, for example smart phones, tablets, and the like.

In the illustrated example, the public transport system comprises at least one route of a subway system having one or more boarding locations 14 and one or more disembarking locations 16 such as passenger terminals or platforms. The transport vehicles 18 comprise subway cars for conveying users along one or more fixed tracks between the various boarding and disembarking locations according to different routes of the system.

In other examples, the transport system may comprise other forms of trains, streetcars, buses, planes, taxis or the like.

The advertising system generally includes a plurality of displays 20 of various forms arranged to display advertising thereon. In a preferred embodiment, the displays are arranged to collectively display video information of various forms. Preferably the displays are arranged to display digital content permitting the content being displayed to be readily changed under computer control. The displays may be located at the boarding or disembarking locations, on the vehicles 18, or more preferably along the route, for example within the tunnel of a subway between different platforms.

The demographic information collection system component of the overall advertising system generally includes a plurality of wireless communication devices 22 in communication with a main server 24 by various means, for example a local area network. The wireless communication devices comprise suitable antennas which are arranged to communicate with the mobile devices of the users by various wireless means including for example Wi-Fi, Bluetooth or the like.

In the instance of a subway system, the devices 22 can be provided at passenger terminals, at the platforms corresponding to the boarding and disembarking locations, in the tunnel along the route at locations either adjacent to the platforms, or at an intermediate location along the route in proximity to the displays 20. In yet a further embodiment, the devices 22 may be provided on the vehicles themselves.

In either instance the devices 22 are arranged to communicate with the mobile devices 15 to obtain device identification information along with any other available information which may be used to make certain demographic assumptions about the user of the mobile device. The mobile device identification together with any other relevant information is communicated to the server for storing on a database of the server. The phone identification is stored and represents an identification of the user of the phone.

Other relevant information which can be determined and stored on the database in association with the user identification includes transport information such as the route identification, the time and date of transport, the boarding location, the disembarking location, or any other relevant transport information.

Yet further information can be obtained from the service provider associated with the phone identification. Also other assumptions can be made based on identifying the phone model through the phone identification. All of the additional information is stored in the database and forms part of the history associated with a particular phone identification. This information can then be used to make certain demographic assumptions, such that the demographic assumptions are further stored in association with the user/phone identification for subsequent access when making advertising decisions as described below.

A programmable computer controller 26 forms part of the system 10 and stores an executable program thereon to direct the function of collection of information through the network of wireless communication devices 22 and the function of storing the information in a suitable archived manner on the database of the server 24.

The controller 26 also communicates through the local network to the plurality of displays 20 to control what advertising content is displayed. Typically a plurality of advertisements are stored on the server or on a local memory of the individual displays to permit different advertising content to be recalled and displayed under command of the controller 26. Each of the plurality of different advertisements includes a different demographic rating associated therewith which may relate to age, gender, economic status, interests and the like.

The program executed by the controller is arranged to gather demographic data associated with all of the users which have been confirmed to be along a particular route associated with one set of displays. The data associated with only the users of the selected route is then viewed collectively and overall demographic information is determined to be representative of the majority of the users so that the program may then select the advertisement having a demographic rating which most closely matches the representative overall demographics of the group of users associated with that particular route at a given time.

Once selected advertising content has been displayed on the displays along a particular route, the demographic information associated with the mobile identifications of the users confirmed to be on that particular route where the advertisement was displayed are stored together with the confirmation on the database of the server as evidence of the viewership of the advertising content. The advertising rates can then be adjusted according to the actual viewership of the content.

Confirmation that the advertisement has been displayed is only determined if various fault detections have passed inspection. Conditions to be met include a desired time of day range, a desired day of week range, a desired demographics of the viewership, a prescribed number of LED's having not failed in the instance of an LED display and a prescribed number of overall displays having not failed in the instance of multiple displays. Further, no emergency message can have been displayed during the advertising content. Invoicing to the relevant parties can then proceed with a full report of viewership details and the resulting advertising rates, once the advertising has been confirmed.

To enhance the demographic information obtained about the users, the advertising system 10 may work together with an application which is executable on the mobile devices 15 of the users such that the application forms part of the demographic information collection system. The mobile device users may be initially prompted on their mobile device through various means, such as by use of the wireless communication devices 22 in communication with a Wi-Fi or Bluetooth connection on the mobile device. Alternatively, the user may be prompted at a boarding location or passenger terminal by other advertising forms or by other communication techniques through a mobile network by using SMS messaging for example.

In either instance, the user is prompted to acquire and download an application through the mobile network or the wireless network of the devices 22 in which the application offers enriched data associated with or related to the advertising content shown on the displays 20. In a preferred embodiment, video is shown on a series of displays along the route of the public transport system while audio content is streamed over the mobile network or any other wireless network, for example Wi-Fi, Bluetooth, or the like. In this instance, the audio content is arranged to be coordinated in synchronicity with the video content on the displays.

When it is desirable to deliver audio over a mobile device synchronized with the video image being displayed on the tunnel mounted sign, two alternative methods of delivering the data to the mobile devices are contemplated. In either instance the mobile application executable on the mobile device is used to play the audio content. In a first instance, the mobile application initiates streaming the audio content over the wireless network at the appropriate time for synchronous play with the video. Alternatively, the audio content is downloaded by the mobile application in the form of preloaded data on the mobile device which has been acquired by said application before displaying the video advertisement to the plurality of users. The audio content can then be played at any time once initiated by the mobile application.

Two alternative actuation methods for initiating playing of the audio content in synchronicity are also contemplated as follows.

In the first instance, when the system is designed to browse available information from passengers waiting on the platform and the speed of the train and the distance down the tunnel to the start of the display along the route are also known, it is possible to compute with reasonable accuracy the time it will take for a passenger on the train to reach the start of the sign. Thus, if that passenger is running the mobile application on their mobile device, the audio can be streamed or pre-loaded to the device and started when the first portion of the video advertisement appears on the display mounted along the route. More particularly, when the video advertisement is initiated by proximity of the public transport vehicle to the independent display mounted along the public transport route, the synchronous playing of the audio content on the mobile device is accomplished by calculating when the mobile device will be in similar proximity to the first display using a departure time of the public transport vehicle from a boarding location, speed of the public transport vehicle along the route, and distance of the independent display along the route from the boarding location.

In an alternative instance, the camera on the mobile device can be used to determine the start of the simultaneous playing of content, particularly audio content, on the mobile devices of the users. Initiating playing of the audio content in synchronicity with the video advertisement is thus accomplished by capturing a visual trigger on the independent display with a camera of the mobile device. If the passenger is running the executable mobile application on their mobile device, the device will use the camera to start the audio based on one of the following two visual triggers: i) the illuminating flash of the first frame of the first display will be used to start the streamed or pre-loaded audio, or ii) the video advertisement can use existing technology that embeds a code in the displayed image. This code will tell the app to start the streamed or pre-loaded audio.

Alternatively the enriched data offered to the mobile device user may simply involve extended advertising content such as more video or a related game for providing supplementary advertising content to the user. In a preferred instance, the auxiliary advertising content comprises video content which is a continuation of the main video advertisement displayed on the independent display along the transport route.

In all instances of a mobile application on the mobile device as described above the method further includes obtaining additional demographic information from the user through the application on the mobile device.

The application requests various permissions from the user before providing access to the enriched data such that the permission obtained by the application permits additional demographic information to be obtained from the mobile device of the user which is then also stored on the database of the server in association with the phone identification representing a user identification. In this manner, over time a large database of analytical data regarding train ridership can be collected. The information is archived such that the controller 26 can access information organized according to a particular route or organized according to a particular user identification.

As described herein, the system will use voluntarily provided information on train passengers to dynamically load and display advertisements as well as gather analytic data to further improve the display of advertisements. Viewers will be invited to download an application on to their smartphone that through various technologies (geo-location, Bluetooth, embedded image hints) will allow participation in a dynamic advertising system. Viewers will be incented to take part based on the provision of additional content, coupons, etc. The system will identify viewers on the platform and stationary trains through Bluetooth connections and geo-locating to best identify the advertisement to display based on the demographic parameters of the passengers.

The machine based advertising work flow of the tunnel display system uses a specific machine based automation process to display ads. The process steps generally are as follows: i) Sales of advertisement based on gathered analytics from train ridership; ii) Digitized ad content pre-distorted and automatically loaded into the display system through a wide area network; iii) Automatic payout of the ad based on train position and speed sensors as well as rider/viewer information gather by the dynamic advertising system; iv) The confirmation of the running of the ad is determined by a dedicated fault monitoring system. The ad is determined to have run if the following conditions are met: desired time of day range; desired day of week range; desired demographics on train; no more than one LED display failed; no more than two pixels on any LED display failed; no presence of emergency message on sign; and v) An invoice process and exception report process follow.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of collecting demographic information relating to a plurality of users of at least one route of a public transportation system, the method comprising:
providing a wireless communication device in proximity to the public transportation system;
communicating wirelessly with any mobile devices of said plurality of users using the wireless communication device so as to determine a mobile device identification of each mobile device of said plurality of users;
storing the mobile device identifications in a computer database; and
storing additional demographic information in association with each mobile device identification on the computer database.

2. The method according to claim 1 including storing demographic information including a route identification of a route of the public transportation system, a transportation boarding location of the user, a transportation disembarking location of the user, a time and date of transport of the user, user information from a mobile service provider, user information derived from an application executed on the mobile device, or any combination thereof.

3. The method according to claim 1 wherein the public transportation system comprises a subway, a train, a streetcar, a bus, a plane, a taxi or the like.

4. The method according to claim 1 including providing the wireless communication device at a boarding location of the public transportation system, a disembarking location of the public transportation system, along a route of the public transportation system, on a vehicle of the public transportation system, or any combination thereof of the public transportation system.

5. The method according to claim 1 including displaying an advertisement to the plurality of users of the public transportation system according to the demographic information associated with the mobile devices of the plurality of users by: i) selecting one advertisement among a plurality of advertisements having a demographic rating which is most closely related to the demographic information associated with the mobile devices of the plurality of users, and ii) displaying the selected advertisement.

6. The method according to claim 1 further comprising: i) displaying an advertisement to the plurality of users of the public transportation system, ii) prompting the mobile devices of the plurality of users to acquire enriched data associated with the advertisement from a mobile network through an application executable on the mobile device, and iii) storing user information derived from said application executable on the mobile device on the computer database in association with the respective mobile device identification.

7. The method according to claim 1 including displaying a visual advertisement to the plurality of users of the public transportation system and providing enriched data to the plurality of users in the form of audio content playable on the mobile device of each user in coordination with the visual advertisement.

8. The method according to claim 7 including streaming the audio content over the mobile network.

9. The method according to claim 1 further comprising:
displaying an advertisement to the plurality of users of the public transportation system according to the demographic information associated with the mobile devices of the plurality of users;
storing a confirmation of the advertisement being displayed on the computer database; and
storing the demographic information associated with the mobile devices of the plurality of users on the computer database in association with the confirmation.

10. The method according to claim 9 further comprising:
displaying the advertisement along a selected route of the public transportation system;
determining which of the plurality of users used said selected route; and
storing demographic information associated with the mobile devices of only the users which used the selected route on the computer database in association with the confirmation of the advertisement being displayed along the selected route.

11. The method according to claim 10 including determining which of the plurality of users used said selected route by communicating wirelessly with the mobile devices of said plurality of users at a boarding location and at a disembarking location for each user.

12. A method of displaying advertising to a plurality of users of mobile devices, the method comprising:
providing a display independent of the mobile devices;
providing a wireless communication device in proximity to the display;
communicating wirelessly with the mobile devices of said plurality of users using the wireless communication device so as to determine a mobile device identification and demographic information associated with each mobile device of said plurality of users;
selecting one advertisement among a plurality of advertisements having a demographic rating which is most closely related to the demographic information associated with the mobile devices of the plurality of users; and
displaying the selected advertisement on the display.

13. The method according to claim 12 further comprising
prompting the mobile devices of the plurality of users to execute an application on the mobile device;
providing enriched data which is associated with the advertisement from a mobile network to the user through said application on the mobile device; and
obtaining additional demographic information from the user through said application on the mobile device.

14. A method of displaying advertising to a plurality of users of mobile devices, the method comprising:
providing a display independent of the mobile devices;
displaying a video advertisement to the plurality of users on the display; and
providing enriched data in the form of audio content which is associated with the advertisement to the plurality of users over a wireless network such that the audio content is playable on the mobile device in synchronicity with the video advertisement.

15. The method according to claim 14 further comprising: i) providing an application executable on the mobile device, and ii) using said application to play the audio content by streaming the audio content over the wireless network.

16. The method according to claim 14 further comprising: i) providing an application executable on the mobile device, and ii) using said application to play the audio content in the form of preloaded data on the mobile device which has been acquired by said application before displaying the video advertisement to the plurality of users.

17. The method according to claim 14 including initiating playing of the audio content in synchronicity with the video advertisement by capturing a visual trigger on the independent display with a camera of the mobile device.

18. The method according to claim 14 wherein: i) the independent display is provided along a public transport route, ii) the mobile device is carried by a user on a public transport vehicle, and iii) the video advertisement is initiated by proximity of the public transport vehicle to the independent display, the method further comprising:
initiating playing of the audio content in synchronicity with the video advertisement by calculating a proximity of the mobile device to the independent display using a departure time of the public transport vehicle from a boarding location, speed of the public transport vehicle along the route, and distance of the independent display along the route from the boarding location.

19.-22. (canceled)
